(19) United States
(12) Patent Application Publication
(10) Pub. No.: US 2017/0249292 A1
(43) Pub. Date: Aug. 31, 2017

(54) CONDITIONAL DETERMINATION OF LOOKUPS IN GLYPH PROCESSING

(71) Applicant: Microsoft Technology Licensing, LLC, Redmond, WA (US)

(72) Inventors: Peter Geoffrey Constable, Redmond, WA (US); Sergey Z. Malkin, Redmond, WA (US); Shrinath Shanbhag, Redmond, WA (US); Robert Matthew McKaughan, Seattle, WA (US); Frank Dwayne Robinson, Redmond, WA (US); Gregory Hitchcock, Woodinville, WA (US); Worachai Chaoweeraprasit, Bellevue, WA (US)

(21) Appl. No.: 15/183,731

(22) Filed: Jun. 15, 2016

Related U.S. Application Data
(60) Provisional application No. 62/301,497, filed on Feb. 29, 2016.

(51) Int. Cl. G06F 17/24; G06F 17/27; G06F 17/21

(52) U.S. Cl. CPC G06F 17/24; G06F 17/211; G06F 17/2705

(57) ABSTRACT

Conditional determination of glyph substitution (GSUB) lookups or glyph positioning (GPOS) lookups in the process of rendering a string of text as a sequence of glyphs is described. A process can include receiving a string of text comprising a sequence of characters, obtaining a sequence of glyph identifiers (IDs) corresponding to the sequence of characters, and determining that a context of the string of text satisfies a condition. Based at least in part on the context satisfying the condition, an alternate lookup can be determined and executed in lieu of a default lookup. Execution of the alternate lookup causes a GSUB operation or a GPOS operation to be performed on the sequence of glyph IDs to ultimately cause the string of text to be rendered on a display as a sequence of glyphs with a typographical feature applied thereto.

### CROSS REFERENCE TO RELATED APPLICATION

This patent application claims the benefit of U.S. Provisional Patent Application Ser. No. 62/301,497 filed Feb. 29, 2016, entitled “CONDITIONAL DETERMINATION OF LOOKUPS IN GLYPH PROCESSING”, which is hereby incorporated in its entirety by reference.

### BACKGROUND

Typography is the art and technique of working with type. Digital typography refers to manipulation and display of digital images produced by a font-using application running on a computing device. Digital typography is based on a hierarchy of objects called font families, fonts or typefaces, and glyphs. The information about a font family is typically stored in a set of font files. A font can be represented as a set of glyphs—a glyph being a visual representation of a character—having common font attributes, such as the same style, weight, and so on. For example, the “Arial” font is represented by a set of glyphs having common features that distinguish the Arial font from other fonts.

Current font formats, such as the OpenType font format, utilize mechanisms for glyph substitution (GSUB) and glyph positioning (GPOS). The GSUB mechanism allows for using one or more glyphs in lieu of another glyph(s), as well as adding, removing, or reordering glyphs. The GSUB mechanism can be used to implement a typographical feature such as a standard ligature feature where a ligature glyph (e.g., the “fi” ligature glyph) is used in lieu of two sequential glyphs (e.g., the “f” glyph followed by the “i” glyph). The GPOS mechanism allows for adjusting the positioning of glyphs relative to each other. The GPOS mechanism can be used to implement a typographical feature such as kerning where the advance width of a glyph is shortened to decrease the spacing between that glyph and the next glyph in sequence.

Current font formats, such as the OpenType font format, can also support a capability called “font variations.” With the concept of font variations, different font design variations can be generated from a single font file for a given font family (e.g., Arial). To support font variations, the single font file uses a mechanism that interpolates different font design parameters between two endpoint values. For example, a weight parameter value can be interpolated between a lighter weight used for regular “Arial” and a heavier weight used for “Arial Black” to generate a unique Arial font with an intermediate weight. Of course, weight is but one example of a font design attribute that can be varied in this manner. Other font design attributes (e.g., width, height, style, etc.) can be varied alone or in combination to achieve a desired font design. The interpolation mechanism controls the degree of the variation of a font design attribute by assigning a parameter value on the font design axis (i.e., a range or continuum of values) to enable text to be rendered with a particular font design. In this manner, a single font family (e.g., Arial) can be defined in a single font file that supports font variations instead of maintaining a separate font file for Arial, a separate font file for Arial Black, and so on.

In some scenarios, the use of font variations creates adverse legibility effects. For example, certain glyphs—such as the dollar sign “$” glyph, Chinese language glyphs, and the like—include a high number of strokes that create a correspondingly high number of counters (i.e., openings in the glyph that are enclosed by the strokes). When font variation mechanisms are used to increase the weight attribute of these types of glyphs, the counters (or openings) in the glyph start to get filled in. For example, with the dollar sign “$” glyph, the counters that are created by the vertical stroke going through the “S” stroke start to get filled in with higher weight font variations. This creates a glyph that is rendered as a black blob, which can be illegible in some scenarios, or at least difficult to recognize. This adverse legibility effect created by font variations is but one example that holds true for any glyph that has a high number of strokes and a correspondingly high number of counters (or openings) in the glyph. Other font variations may create similar adverse legibility effects.

### SUMMARY

Described herein are techniques and systems for conditional determination (sometimes referred to herein as “conditional filtering”) of glyph substitution (GSUB) lookups or glyph positioning (GPOS) lookups in the process of rendering a string of text as a sequence of glyphs. If a context of a string of text does not satisfy a predefined condition (or a set of conditions), a default list of GSUB lookups or a default list of GPOS lookups can be executed. If, on the other hand, the context of the string of text satisfies the predefined condition (or the set of conditions), an alternate list of GSUB lookups or an alternate list of GPOS lookups can be executed in lieu of the default GSUB lookup or the default GPOS lookup, respectively. In this manner, a particular typographical feature associated with the alternate list of GSUB lookups or the alternate list of GPOS lookups can be implemented to achieve a desired result in the event that the predefined condition is satisfied.

In some configurations, a process of rendering a string of text as a sequence of positioned glyphs includes receiving a string of text comprising a sequence of characters, obtaining a sequence of glyph identifiers (IDs) corresponding to the sequence of characters, and determining that a context of the string of text satisfies a condition. Based at least in part on the context satisfying the condition, an alternate lookup can be determined and executed in lieu of a default lookup. The alternate lookup can comprise a GSUB lookup or a GPOS lookup, and can be executed to cause the string of text to be rendered on a display as a sequence of glyphs with a typographical feature applied thereto.

In some configurations, the condition is satisfied when a context of the string of text comprises a value within a predefined range of values on a font design variation axis. An example of a font design variation axis is a weight axis. Thus, for a font that supports a font design variation on the weight axis, a default glyph ID for a character can be substituted with a different glyph ID when the weight value specified for the string of text is within the predefined range of weight values (i.e., when the condition is satisfied). Accordingly, conditions can be defined that, if satisfied, cause performance of different GSUB lookups and/or different GPOS lookups in lieu of default GSUB lookups and/or default GPOS lookups, respectively.

Conditional determination of GSUB lookups provides the ability to substitute different glyphs when a particular condition is satisfied in order to, among other things, preserve legibility of the rendered text in particular scenarios. For example, when text is to be rendered at a relatively heavy weight as defined by a range of weight values on the weight axis, the techniques described herein can be used to replace a default glyph with many strokes (and many corresponding counters) with a substitute glyph having a reduced number or extent of strokes to preserve the legibility of the glyph at the heavier weight.

Conditional determination of GPOS lookups provides the ability to modify the positions of glyphs relative to each other when a particular condition is satisfied. For example, a kerning feature can be implemented differently (i.e., to a different extent) depending on the weight and/or style of the text to be rendered. In addition to substituting different GSUB/GPOS lookups for default GSUB/GPOS lookups, the conditional filtering techniques described herein can also be used to effectively toggle the GSUB/GPOS mechanisms “on” or “off,” depending on whether a condition is satisfied. For example, the system can refrain from performing a ligature glyph substitution if the text to be rendered is in a vertical layout direction, effectively toggling the GSUB lookup for the ligature glyph substitution “off” when the condition (e.g., vertical layout direction) is satisfied.

This Summary is provided to introduce a selection of concepts in a simplified form that is further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

The detailed description is described with reference to the accompanying figures. In the figures, the left-most digit(s) of a reference number identifies the figure in which the reference number first appears. The same reference numbers in different figures indicates similar or identical items.

FIG. 1 illustrates an example computing device configured to process glyphs by conditionally determining glyph substitution (GSUB) lookups and/or glyph positioning (GPOS) lookups.

FIG. 2 is a flow diagram of an example process of processing glyphs by conditionally determining GSUB lookups and/or GPOS lookups.

FIG. 3A is a schematic diagram of an example conditional filtering scenario.

FIG. 3B is a schematic diagram of another example conditional filtering scenario.

FIG. 3C is a schematic diagram of another example conditional filtering scenario

FIG. 4A is a flow diagram of a more detailed example process of conditionally determining GSUB lookups.

FIG. 4B is a flow diagram of a more detailed example process of conditionally determining GPOS lookups.

### DETAILED DESCRIPTION

Configurations of the present disclosure are directed to, among other things, techniques and systems for conditional determination of glyph substitution (GSUB) lookups or glyph positioning (GPOS) lookups in the process of rendering a string of text as a sequence of positioned glyphs. It is to be appreciated that the techniques described herein can be implemented by enhancing a specification for a given font format, such as by enhancing the OpenType font specification. For instance, the OpenType font specification can be enhanced to include data structures within existing font tables that are used for specifying conditions that, if satisfied, cause substitute GSUB and/or GPOS lookups to be used in lieu of default GSUB and/or GPOS lookups, respectively. In this manner, conditional filtering can be implemented in a backwards compatible fashion so that legacy systems and software can still output sensible behavior, even if the legacy systems cannot interpret the new data structures added to the existing font tables. In other words, the techniques and systems described herein can be deployed without breaking legacy systems and rendering them inoperable for purposes of processing glyphs and rendering text.

Furthermore, enhancing the existing specification for a given font format in the manner described herein provides an extensible system for conditional filtering of GSUB and/or GPOS lookups. For instance, if a font developer desires to specify a new type of condition, the new type of condition can be added to an existing condition set in the new data structure within the font tables without having to redesign the data structure itself. In this scenario, if a legacy system does not recognize the new type of condition, it is simply ignored, and the legacy system can fallback to minimal default behavior in order to render text on the display.

By the use of the techniques disclosed herein, one or more devices can be configured to conserve resources with respect to power resources, memory resources, communications bandwidth resources, processing resources, and/or other resources while providing mechanisms for conditional filtering of GSUB lookups or GPOS lookups in the process of rendering a string of text as a sequence of glyphs. For example, memory resources can be conserved by not having to store separate font files for all possible font design variations. Rather, a single font file supporting font variations for a given font family can be utilized to implement font variations with conditional filtering of GSUB lookups and/or GPOS lookups, conserving memory resources as a result. As another example, information pertaining to alternate GSUB lookups and/or GPOS lookups can be cached after an initial glyph processing procedure is completed. This allows the cached information to be used so that processing resources can be conserved for other applications and processes. Technical effects other than those mentioned herein can also be realized from an implementation of the technologies disclosed herein.

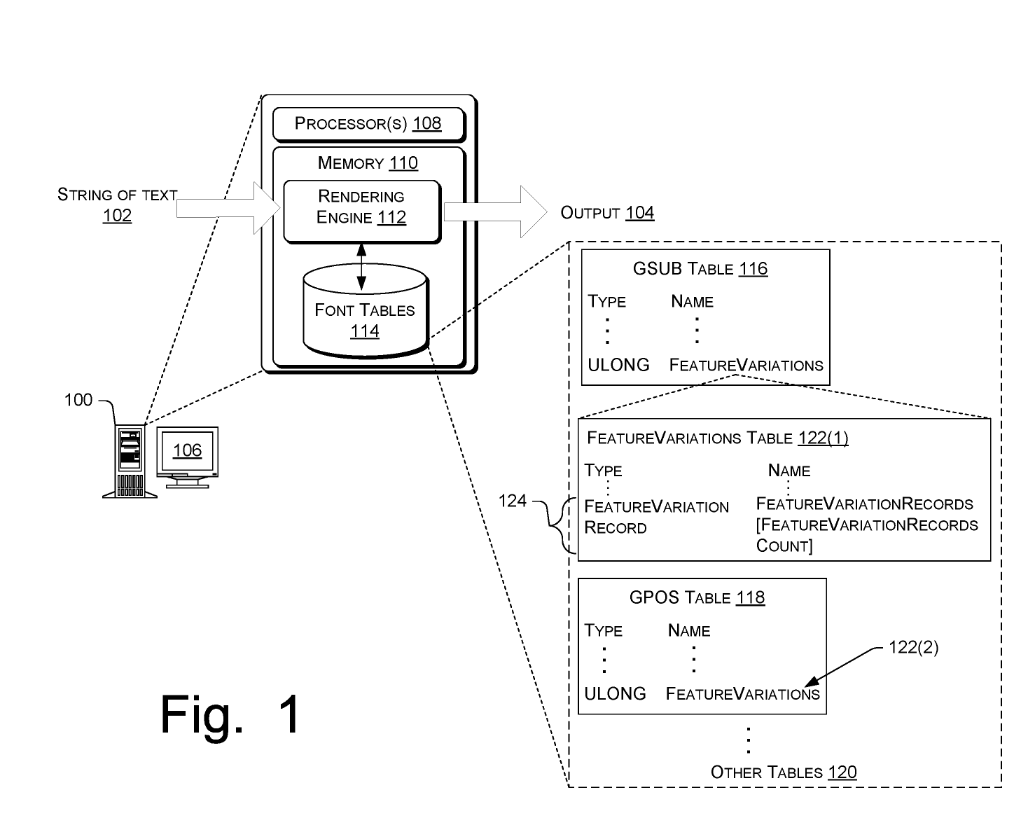

FIG. 1 illustrates an example computing device 100 configured to process glyphs by conditionally determining glyph substitution (GSUB) lookups and/or glyph positioning (GPOS) lookups. In general, the computing device 100 is configured to receive a string of text 102, perform glyph processing operations for the string of text, and provide output 104 to a target device, such as a display buffer, a printer buffer, or a file (e.g., PDF, JPEG, etc.), for rendering, on an associated display or medium (e.g., paper), a sequence of positioned glyphs representing the string of text 102 in a given font.

The computing device 100 (sometimes referred to herein as a “client device 100”) can be implemented as any type of computing device, including, without limitation, a personal computer, a laptop computer, a desktop computer, a portable digital assistant (PDA), a mobile phone, tablet computer, an electronic book (eBook) reader device, a set-top box, a game console, a smart television, a wearable device (e.g., a smart watch, electronic “smart” glasses, a fitness tracker, etc.), or any other electronic device that is configured to render text on an associated target device, such as a display 106 or a printer.

The computing device 100 is shown as being equipped with one or more processors 108 and one or more forms of computer-readable memory 110. The processor(s) 108 can be configured to execute instructions, applications, or programs stored in the memory 110. In some configurations, the processor(s) 108 can include hardware processors that include, without limitation, a hardware central processing unit (CPU), a field programmable gate array (FPGA), a complex programmable logic device (CPLD), an application specific integrated circuit (ASIC), a system-on-chip (SoC), or a combination thereof.

Computer-readable media can include two types of computer-readable media, namely computer storage media and communication media. The memory 110 is an example of computer storage media. Computer storage media can include volatile and non-volatile, removable, and non-removable media implemented in any method or technology for storage of information, such as computer readable instructions, data structures, program modules, or other data. Computer storage media includes, but is not limited to, random access memory (RAM), read-only memory (ROM), erasable programmable read-only memory (EEPROM), flash memory or other memory technology, compact disc read-only memory (CD-ROM), DVD, or other optical storage, magnetic cassettes, magnetic tape, magnetic disk storage or other magnetic storage devices, or any other non-transmission medium that can be used to store the desired information and that can be accessed by the processor(s) 108. Any such computer storage media can be part of the computing device 100. In general, computer storage media can include computer-executable instructions that, when executed by the processor(s) 108, perform various functions and/or operations described herein.

In contrast, communication media embody computer-readable instructions, data structures, program modules, or other data in a modulated data signal, such as a carrier wave, or other transmission mechanism. As defined herein, computer storage media does not include communication media.

In some configurations, the string of text 102 can be received from a local source on the computing device 100 via an application executing on the computing device 100. For example, an electronic book (eBook) that has been downloaded to the computing device 100 can be retrieved from local memory 110 via an eBook application that is configured to present text from the eBook on the display 106 of the computing device 100. In other configurations, the computing device 100 can be configured to transmit/receive data over a network(s), such as a wired and/or wireless network(s) that enables communication between the computing device 100 and other computing devices over the network(s). For example, the string of text 102 can be retrieved from a server computer over the network via a web browser application in order to present text from a web page on the display 106 of the computing device 100. In this scenario, the network—over which the string of text 102 is transmitted to the computing device 100—can comprise a cable network, the Internet, a local area network (LAN), a wide area network (WAN), a mobile telephone network (MTN), or any other type(s) of network, possibly used in conjunction with one another, to facilitate the receipt of the string of text 102 at the computing device 100.

Examples of font-using applications that can be executed on the computing device 100 for purposes of rendering text on a target device include, without limitation, word processing applications, spreadsheet applications, desktop publishing applications, eBook applications, web browsers, or any other type of font-using application used for rendering text on a display 106 and/or a printer associated with the computing device 100. Such applications can be built into, or downloaded after manufacture to, the computing device 100 and executed thereon. Alternatively, an application can be stored in a server and executed “in the cloud” as part of a thin-client implementation to render text on a target device associated with the computing device 100.

The computer-readable memory 110 can include a rendering engine 112 that is used by a font-using application to render the string of text 102 on a target device in accordance with a font format. For example, the OpenType font format can be used to configure the rendering engine 112 to process data structures and information within a plurality of font tables 114 or similar data structures for purposes of rendering the string of text 102 as a sequence of glyphs on a target device. In general, the font tables 114 store glyph information, which can include, without limitation, glyph identifiers (IDs), glyph metrics, outline data (e.g., points that make up a Bezier curve) usable for rendering glyphs, character map (cmap) tables for mapping characters to glyph IDs, script tables, language system (LangSys) tables, feature tables, lookup tables, and so on. FIG. 1 illustrates that the font tables 114 can further include a glyph substitution (GSUB) table 116 and a glyph positioning (GPOS) table 118, among other tables 120, which are available to the rendering engine 112 for processing glyphs. It is to be appreciated that the example data structures described herein are presented merely for illustrative purposes and that other types of data structures and data representations can be used to implement the techniques described herein without changing the basic characteristics described herein. Before discussing the details of the GSUB table 116 and the GPOS table 118, a brief background on glyph processing using GSUB and GPOS mechanisms is provided.

OpenType fonts can be defined for different scripts, such as Latin, Arabic, Greek, Cyrillic, and so on. Each script can include a list of languages, such as English, German, Spanish, Hindi, and so on. The rendering engine 112 can be configured to implement a list of “features” (sometimes called “typographic features”) that are used to deliver a typographic effect to the glyphs that are ultimately rendered on the display 106. Some of these features can be used for rendering text properly in a given language system for a particular script, while other features can be discretionary features (e.g., use of proportional-width numerals vs. “tabular” fixed-width numerals) that are selected by a content author, by the application, or possibly a content viewer. In general, a “feature” is a trigger or control mechanism for OpenType Layout actions like GSUB actions (i.e., substitution of glyphs) and GPOS actions (i.e., positioning of glyphs). Said another way, a feature can be thought of as an abstract intent of the kind of typography that a font developer wants to implement, and the GSUB and GPOS mechanisms are used to deliver the feature in the process of rendering text on a target device.

Each feature can be designated by a feature name, and the rendering engine 112 or an application using the rendering engine 112 determines whether the feature is to be applied when text is rendered, assuming the font supports the feature. The feature name can be a four-byte sequence of characters (e.g., “liga” for the standard ligatures feature). Features can include replacement features and positioning features. Replacement features involve GSUB actions and can include, without limitation, features such as standard ligatures, historic ligatures, small capitals, and so on. For example, the standard ligatures feature triggers particular GSUB actions, such as substituting the “fi” ligature glyph for two sequential glyphs: the “f” glyph followed by the “i” glyph in the string of text 102. Positioning features involve GPOS actions and can include, without limitation, features such as kerning, mark placement, baseline specification, and so on. For example, the kerning feature triggers particular GPOS actions, such as shortening the advance width of a “V” glyph when followed by an “A” glyph in the string of text 102 so that the two sequential glyphs are moved closer together.

Each feature can be defined by a feature record and a feature table. The feature record includes the feature name (called a “feature tag”) and an offset to the feature table. The feature table includes a list of lookup references (e.g., indices, offsets, and the like) that point to a set (or list) of “lookups” that are to be used to implement the feature in question. A “lookup” is an action that is triggered by one or more features to deliver a typographic effect to the glyphs that represent the string of text 102. One type of lookup is a GSUB lookup, and there can be various types of GSUB lookups including, without limitation, a GSUB lookup to replace one glyph with multiple glyphs, a GSUB lookup to replace multiple glyphs with one glyph, a GSUB lookup to replace a single glyph with another single glyph, a GSUB lookup to substitute a ligature glyph for multiple glyphs, and so on. Another type of lookup is a GPOS lookup, and there can be various types of GPOS lookups including, without limitation, a GPOS lookup for repositioning a single glyph when the glyph is in a “before” or “after” context (i.e., preceding or following another glyph in sequence), repositioning two side-by-side glyphs, repositioning a mark (e.g., an accent, a diacritical mark, etc.), and so on. Accordingly, a “lookup,” as the term is used herein, can correspond to any suitable glyph substitution action or glyph positioning action that is to be taken, and lookups can be executed to carry out the GSUB actions and/or GPOS actions that deliver the typographic effect for the feature in question.

Accordingly, the OpenType font format includes an OpenType Layout capability that utilizes GSUB and GPOS mechanisms to support many different languages and many different typographic effects in particular languages. In order to utilize the GSUB mechanism, the rendering engine 112 can process the GSUB table 116 at runtime in order to execute GSUB lookups for various features that are to be applied for a given language system. In order to utilize the GPOS mechanism, the rendering engine 112 can process the GPOS table 118 in a similar manner.

An example of the GSUB table 116 (also shown in FIG. 1) is presented, at least in part, in the following table:

GSUB Table

| Type | Name | Description |
|---|---|---|
| Fixed | Version | Version of the GSUB table, = 0x00010001 |
| Offset | ScriptList | Offset to ScriptList table-from beginning |
| | | of GSUB table |
| Offset | FeatureList | Offset to FeatureList table-from beginning |
| | | of GSUB table |
| Offset | LookupList | Offset to LookupList table-from beginning |
| | | of GSUB table |
| ULONG | FeatureVariations | Offset to Feature Variations table from |
| | | beginning of GSUB. Optional; if not |
| | | present, set to 0 |

The data structures in the above example GSUB table 116 can be included in the header of the GSUB table 116. The “version” can correspond to a version of the GSUB table 116 that provides extensibility. For example, as new conditions and GSUB actions are defined for a particular feature, future versions of the GSUB table 116 can be defined to implement those new conditions and GSUB actions. The “ScriptList” can include an array of offsets to script tables, and each script table can include a script tag (e.g., a four-byte sequence of characters) for a given script (e.g., “arab” for the Arabic script), as well as an array of offsets to a set of corresponding language system (LangSys) tables. For example a script table for the Latin script can include an array of offsets to different languages within the Latin script, where each language in the Latin script can have different typographic requirements to implement different typographic behaviors on a language-specific basis. An individual language system table can include an array of offsets to a particular set of feature tables (e.g., feature table/tag pairs) that are included in the “FeatureList” of the above example GSUB table 116. The particular set of feature tables can be specified within a given language system table to provide the set of features that are supported for a given script and language system. Thus, a given language table for a particular language can specify the relevant features (i.e., indices to feature tables in the “FeatureList”) for the script and language in question.

The “FeatureList” is a data structure that includes an array of offsets to feature tables and associated feature tags for different features. Lookups (in this case, GSUB lookups) are activated by features, and the set of lookups activated for a given feature and language system is defined in a feature table. Accordingly, the “LookupList” is a data structure that includes an array of offsets to lookups (i.e., GSUB lookups) that are triggered by one or more features.

The example GSUB table 116 shown above, and in FIG. 1, can further include a data structure 122(1) (sometimes called a “feature variations table 122(1)”) that specifies a set of conditions that, when satisfied, cause alternate GSUB lookups to be executed in lieu of default GSUB lookups defined in a given feature table. That is, the feature variations table 122(1) can be processed by the rendering engine 112 at runtime to allow the GSUB lookups executed for a given feature to vary based on one or more conditions.

In a similar manner, an example of the GPOS table 118 (also shown in FIG. 1) is presented, at least in part, in the following table:

GPOS Table

| Type | Name | Description |
|---|---|---|
| Fixed | Version | Version of the GPOS table = 0x00010001 |
| Offset | ScriptList | Offset to ScriptList table-from beginning |
| | | of GPOS table |
| Offset | FeatureList | Offset to FeatureList table-from beginning |
| | | of GPOS table |
| Offset | LookupList | Offset to LookupList table-from beginning |
| | | of GPOS table |
| ULONG | FeatureVariations | Offset to Feature Variations table from |
| | | beginning of GPOS. Optional; if not |
| | | present, set to 0. |

The data structures in the above example GPOS table 118 can be similar to the data structures of the example GSUB table 116, except that the particular lookups and features included in the LookupList and the FeatureList, respectively, are based on GPOS actions rather than GSUB actions. Accordingly, the example GPOS table 118 shown above, and in FIG. 1, can further include a data structure 122(2) (or “feature variations table 122(2)”) that specifies a set of conditions that, when satisfied, cause alternate GPOS lookups to be executed in lieu of default GPOS lookups defined in a given feature table. That is, the feature variations table 122(2) can be processed by the rendering engine 112 at runtime to allow the GPOS lookups executed for a given feature to vary based on one or more conditions. It is to be appreciated that the respective feature variations tables 122(1) and 122(2) can be defined for GSUB lookups and GPOS lookups, respectively. However, for illustrative purposes, the data structures 122(1) and 122(2) will be described collectively with reference to a general feature variations table 122, which can be similarly applied in the respective circumstances.

The feature variations table 122 can be used to specify variations on the effects of features based on various conditions. An example of the feature variations table 122 (also shown in FIG. 1 for reference numeral 122(1)) is shown, at least in part, in the following table:

Feature Variations Table

| Type | Name | Description |
|---|---|---|
| Fixed | version | Version of the |
| | | FeatureVariations |
| | | table, = |
| | | 0x00010000 |
| ULONG | FeatureVariationRecordsCount | Number of |
| | | feature |
| | | variation |
| | | records. |
| FeatureVariationRecord | FeatureVariationRecords[FeatureVariationRecordCount] | Array of |
| | | feature |
| | | variation |
| | | records |

The data structures in the above example feature variations table 122 can include an array of feature variation records 124. Each of the feature variation records 124 can reference (i) a set of conditions (defined in a condition set table described below), and (ii) a set of alternate feature tables to use when a runtime context of the string of text 102 satisfies (or matches) the set of conditions. This allows for replacing one feature table for another feature table at runtime to conditionally filter the lookups (e.g., GSUB lookups and/or GPOS lookups) executed for a given feature in order to deliver a particular typographic effect.

The alternate feature tables can be appended at the end of the feature variations table 122, and, in some configurations, are not included in the feature list table (e.g., the alternate feature tables for GSUB actions are not included the “FeatureList” in the GSUB table 116). Hence, in some configurations, there are no feature records in the feature list table (“FeatureList”) that correspond to the alternate feature tables to be used in lieu of the default feature tables when a condition set is satisfied. The feature tables specified in a language system table can be used by default when a runtime context of the string of text 102 does not satisfy any of the conditions for variation defined in the feature variations table 122. The default feature tables can also be used under all conditions in implementations that do not support the feature variations table 122, which allows for backward compatibility with legacy systems and software. An alternate feature table can maintain the same feature tag association as the default feature table for a given feature. Also, in some configurations, whereas the default feature tables in the feature list table (“FeatureList”) can be referenced using 16-bit offsets, the alternate feature tables appended at the end of the feature variations table 122 can be referenced using 32-bit offsets within the feature variations table 122.

An example of a feature variation record 124 is shown, at least in part, in the following table:

Feature Variation Record

| Type | Name | Description |
|---|---|---|
| ULONG | ConditionSet | Offset to a condition set table, |
| | | from the beginning of the |
| | | FeatureVariations table. |
| ULONG | FeatureTableSubstitution | Offset to a feature table |
| | | substitution table, from the |
| | | beginning of the |
| | | FeatureVariations table. |

As shown in the above table, the feature variation record 124 can include an offset to a “condition set table” and an offset to a “feature table substitution table.” If the ConditionSet offset in the feature variation record 124 is 0, there is no condition set table. This is treated as the universal condition: all contexts are matched. If the FeatureTableSubstitution offset in the feature variation record 124 is 0, there is no feature table substitution table, and no substitutions are made for the default feature tables specified in a language system table.

In some configurations, a plurality of feature variation records 124 in the feature variations table 122 can be ordered in an order of precedence for the condition sets. During processing, the plurality of feature variation records 124 can be read by the rendering engine 112, and the corresponding condition sets tested, in the order in which the plurality of feature variation records 124 occur in the feature variations table 122. The first feature variation record 124 for which the condition set matches the runtime context (i.e., the condition set is satisfied by the runtime context of the string of text 102) can be considered as a candidate. If the version of the feature table substitution table is supported, then this feature variation record 124 can be used, and the rendering engine 112 may not consider any additional feature variation record 124 in the list of feature variation records 124. If the version of the feature table substitution table is not supported, then this feature variation record 124 can be rejected and the rendering engine 112 can proceed to the next feature variation record 124 in the ordered list of feature variation records 124. By testing the version of the feature table substitution table and rejecting if not supported, backwards compatibility can be provided. That is, a font developer can create new fonts that will display sensibly on legacy software in a way that the font developer determines.

An example of a condition set table within a feature variation record 124 is shown, at least in part, in the following table:

Condition Set Table

| Type | Name | Description |
|---|---|---|
| Fixed | Version | Version of the ConditionSet table, = |
| | | 0x00010000 |
| uint16 | ConditionCount | Number of conditions for this |
| | | condition set |
| ULONG | ConditionTable[ConditionCount] | Array of offsets to condition tables, |
| | | from the beginning of the |
| | | ConditionSet |

The example condition set table shown above can specify a set of conditions (defined by condition tables) under which a feature table substitution table is to be applied. A set of conditions can specify conditions related to various factors, including, but not limited to, a predefined range of values on the font design variation axis, a layout direction of text, or the version of a font format (e.g., a version of the OpenType font format).

For a given condition set, the conditions can be conjunctively related (Boolean AND), meaning all of the specified conditions are to be met in order for the associated feature table substitution table to be applied. A condition set does not need to specify conditional values for all possible factors. For example, if the condition set does not include any condition for text layout direction, then that condition set matches any text layout direction. If a given condition set contains no conditions, then it matches all contexts, and the associated feature table substitution table is always applied, unless there is a condition record earlier in the feature variations table 122 with a condition set matching the current context.

Individual conditions can be represented in respective condition tables that describe the particular condition. As noted above, a condition table can be defined based on various factors by defining the condition table in terms of one of multiple different formats that represent different types of conditions according to the nature of the factor defining the condition. For example, a first format (Format 1) for a condition table can be defined for a text layout direction, a second format (Format 2) for a condition table can be defined for a predefined range of values on the font design variation axis, and a third format (Format 3) for a condition table can be defined for a version of a font format (e.g., OpenType version). It is to be appreciated that additional formats for additional condition qualifiers can be used with the techniques and systems described herein, and new condition table formats can be added by updating the version of the condition set table. Accordingly, if the rendering engine 112 supports a particular version of the condition set table and encounters a font with a later-version condition set table, the rendering engine 112 may fail to match the condition set whenever an unrecognized condition format is encountered, and then proceed to evaluate additional feature variation records 124 with different condition sets that may conform to an earlier version of the condition set table. In this way, new condition formats can be defined and used in fonts that work in a backwards-compatible manner. Therefore, introduction of new condition formats will typically result in minor version updates to the condition set table.

An example of a condition table of Format 1 (text layout direction) is shown, at least in part, in the following table:

Condition Table Format 1: Text Layout Direction

| Type | Name | Description |
|---|---|---|
| uint16 | Format | Format, = 1 |
| uint16 | LayoutDirectionFlag | Direction qualifiers. |

Layout direction refers to processing modes in an OpenType client for a given string of text 102. The layout direction can be the resolved direction after bidi layout is applied, including any directional overrides. The OpenType client can apply its own higher-level protocols to determine layout direction. A layout direction condition can refer to horizontal or vertical layout modes, if this is provided by the application, and horizontal layout can be assumed by default. If multiple flags are set, the combination is considered disjunctively (Boolean OR), meaning the condition matches contexts with any of the specified directions. If a Format 1 condition is present but no flags are set, then the condition does not match for any context. Absence of a Format 1 condition implies that layout direction is not a factor in determining applicability of the condition set.

The following table shows the interpretation for the layout direction flag in the Format 1 condition table:

Layout Direction Flag Interpretation Table

| Type | Name | Description |
|---|---|---|
| 0x0001 | LeftToRight | Resolved horizontal text direction is LTR |
| 0x0002 | RightToLeft | Resolved horizontal text direction is RTL |
| 0x0004 | TopToBottom | Resolved vertical text direction is TTB |
| 0x0008 | BottomToTop | Resolved vertical text direction is BTT |

An example of a condition table of Format 2 (a predefined range of values on the font design variation axis) is shown, at least in part, in the following table:

Condition Table Format 2: Font Variation Value Range

| Type | Name | Description |
|---|---|---|
| uint16 | Format | Format, = 2 |
| uint16 | AxisIndex | Index for design axis within the ‘fvar’ |
| | | table, base 0. |
| shortfrac | FilterRangeMinValue | Minimum value of the font variation |
| | | instances that satisfy this condition |
| shortfrac | FilterRangeMaxValue | Maximum value of the font variation |
| | | instances that satisfy this condition |

A font variation value range condition refers to a predefined range of values for a design axis specified in an ‘fvar’ table of a font. The fvar table can comprise a data structure containing information about which font design variation axes are included in the font. If a Format 2 condition table is used, the font is to include an ‘fvar’ table, and the AxisIndex value (which is base 0) can be less than the axisCount value in the ‘fvar’ table. A condition can specify a range that exceeds the min/max range for the axis specified in the ‘fvar’ table, but the ‘fvar’ table determines the range that can be realized for the font in question. Thus, values outside the range defined in the ‘fvar’ table for the given axis can be ignored.

A font variation value range condition can be satisfied if the font variation instance being used for text layout (i.e., the context of the string of text 102) has a value for the given font design variation axis that is greater than or equal to the FilterRangeMinValue, and that is less than or equal to the FilterRangeMaxValue. Absence of a Format 2 condition for a given font design variation axis implies that that axis is not a factor in determining applicability of the condition set.

An example of a condition table of Format 3 (font format version) is shown, at least in part, in the following table:

Condition Table Format 3: Font Format
(e.g., OpenType Layout) Version

| Type | Name | Description |
|---|---|---|
| uint16 | Format | Format, = 3 |
| uint16 | OpenTypeLayoutMajorVersion | The minimum major version |
| | | of the OpenType specification |
| uint16 | OpenTypeLayoutMinorVersion | The minimum minor version |
| | | of the OpenType specification |

A font format (e.g., OpenType Layout) version condition refers to a minimal version of the font format (e.g., OpenType) specification required to process the lookups referenced in the substituted feature table. If the maximum version supported by the layout implementation is greater than or equal to the version in the condition, then the condition is satisfied. Absence of a Format 3 condition implies that the supported font format (e.g., OpenType) version is not a factor in determining applicability of the condition set.

As an illustrative example, mark glyph sets are introduced in version 1.2 of the ‘GDEF’ table in OpenType version 1.6. If a font has lookups that depend on this mechanism, then a condition set can specify version 1.6 of the OpenType format as a minimal requirement. If there are other lookups that provide a fallback behavior on legacy implementations that don't support mark glyph sets, then the alternate lookups can be referenced in a feature table selected in response to satisfying a subsequently evaluated condition set. Alternatively, one of the behaviors can be provided by a default feature table with the other behavior selected by a condition set in the feature variations table 122. For example, a legacy system that supports OpenType version 1.6, but not OpenType version 2.0, would not be able to alternate between the older or newer behaviors. A new font can be created to work on OpenType version 1.5 implementations by using lookups that don't require mark glyph sets by default, and then selecting the alternate behavior using mark glyph sets via a feature variations table 122.

An example of a feature table substitution table within a feature variation record 124 is shown, at least in part, in the following table:

Feature Table Substitution Table

| Type | Name | Description |
|---|---|---|
| Fixed | Version | Version of the |
| | | FeatureTableSubstitution |
| | | table, = |
| | | 0x00010000 |
| uint16 | SubstitutionCount | Number of feature |
| | | table substitution |
| | | records |
| FeatureTableSubstitutionRecord | Substitutions[SubstitutionCount] | Array of feature table |
| | | substitution records |

The example feature table substitution table shown above describes a set of feature table substitutions to be applied when the corresponding condition set is satisfied by the current runtime context of the string of text 102. These substitutions are represented using an array of “feature table substitution records.” The feature table substitution records can be ordered in increasing order of unique FeatureIndex values (i.e., no two records can have the same FeatureIndex value).

Condition sets can be evaluated and selected for processing of the associated feature table substitution table to revise a default array of feature tables derived from a language system table. For example, for each feature index, the feature table substitution records can be evaluated in order. When a matching record is encountered (FeatureIndex=the current feature index), the feature table for that feature index can be replaced by the substitute feature table at the offset given in the feature table substitution record and processing for that feature index stops.

An example of a feature table substitution record within a feature table substitution table is shown, at least in part, in the following table:

Feature Table Substitution Record

| Type | Name | Description |
|---|---|---|
| unit16 | FeatureIndex | The feature index to match |
| ULONG | AlternateFeatureTableOffset | Offset to an alternate feature |
| | | table, from the start of the |
| | | FeatureTableSubstitution |
| | | table. |

The example feature table substitution record shown above provides a substitution of an alternate feature table for a default feature table. The default feature table is referenced as an index into the feature list table (the “FeatureList”). The alternate feature table is referenced as an offset from the start of the feature variations table 122. It is to be appreciated that the details described herein with regards to processing condition sets specified in the feature variations table 122 can be applied similarly for both GSUB lookups and GPOS lookups, the difference being in the specific features and lookups defined in the GSUB and GPOS tables.

The processes described herein are illustrated as a collection of blocks in a logical flow graph, which represent a sequence of operations that can be implemented in hardware, software, or a combination thereof. In the context of software, the blocks represent computer-executable instructions stored on one or more computer-readable storage media that, when executed by one or more processors, perform the recited operations. Generally, computer-executable instructions include routines, programs, objects, components, data structures, and the like that perform particular functions or implement particular abstract data types. The order in which the operations are described is not intended to be construed as a limitation, and any number of the described blocks can be combined in any order and/or in parallel to implement the process. Moreover, in some configurations, one or more blocks of the processes can be omitted entirely.

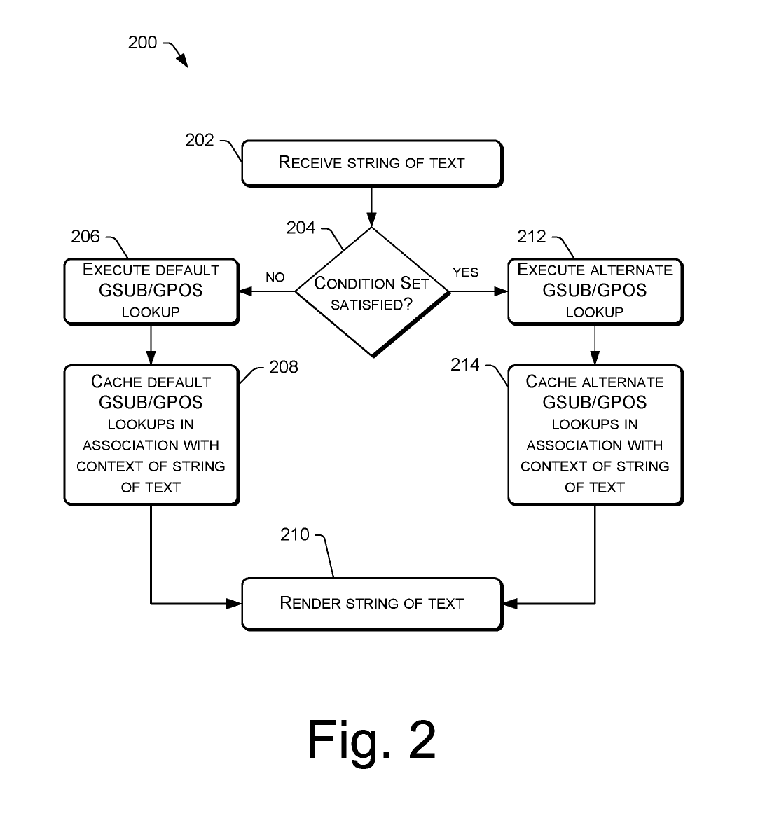

FIG. 2 is a flow diagram of an example process 200 of processing glyphs by conditionally determining GSUB lookups and/or GPOS lookups. The process 200 is described with reference to the components of FIG. 1 and the data structures described herein. Particular reference may be made to the rendering engine 112, the GSUB table 116, GPOS table 118, and the feature variations table 122 of FIG. 1.

At 202, the rendering engine 112 receives a string of text 102. The string of text 102 can be received from a local memory resource, or from a computing device over a network(s). The string of text 102 can comprise a sequence of characters associated with a language. For example, the sequence of characters can comprise the character “o”, followed by the character “f”, followed by the character “f”, followed by the character “i”, followed by the character “c”, followed by the character “e” to form the word “office.”

The string of text 102 can be associated with a font type attribute that defines the type of font (e.g., Arial) that is to be used for rendering the string of text 102 as a sequence of glyphs. In this manner, the sequence of characters can be mapped to a sequence of glyph IDs for the font file in question. For example, the glyph IDs can correspond to glyphs that are defined for the Arial font. When the sting of text 102 is initially received, the rendering engine 112 can reference a character map (cmap) table for the font file in question, which contains a default glyph mapping from each character to a default glyph ID. Thus, the rendering engine 112 can obtain a default sequence of glyph IDs corresponding to the sequence of characters. Subsequently, glyph substitutions can be made with respect to the default sequence of glyph IDs in the process of applying one or more typographic features, which results in a different sequence of glyph IDs with at least one default glyph ID replaced with a substitute glyph ID. In either scenario, the sequence of characters in the string of text 102 can be associated with a sequence of glyph IDs.

At 204, a determination is made as to whether a context of the string of text 102 satisfies a set of conditions. The context of the string of text 102 can comprise information extracted from the received string of text 102, information derived from the string of text 102, and/or information that is at least partially, or entirely, external to the string of text 102. For example, the context can comprise a resolved layout direction for display of the text, which can be derived in part from the string of text 102, and in part from information or inputs associated with an application or computing environment involved in displaying the text. As another example, the context can comprise an instance value for a font design variation axis or a supported version of a font format (e.g., OpenType font format), which can be independent of (or external to) the string of text 102. The set of conditions evaluated at 204 can include any suitable conditions described herein and specifiable in the font variations table 122, such as an instance value associated with a font design attribute (e.g., weight) being within a predefined range of values on the font design variation axis, a layout direction being a particular layout direction or a particular subset of possible layout directions, or a version of a font format being at or above a minimum version of the font format, and the like. The set of conditions evaluated at 204 can include any number of conditions, including a set of conditions with a single condition or multiple conditions. Furthermore, the set of conditions can be satisfied if all of the conditions in the set of conditions are satisfied, if a predefined number of conditions in the set of conditions are satisfied, or if an individual condition in the set of conditions are satisfied.

If, at 204, the rendering engine 112 determines that the set of conditions is not satisfied, the process 200 proceeds down the “No” path to 206 where a default list of lookups associated with the language in question (i.e., a list of lookups specified in a default feature table within the relevant language system table) is determined and executed to cause a glyph substitution (i.e., GSUB lookups) or a glyph positioning (i.e., GPOS lookups) operation(s) to be performed on the sequence of glyph IDs corresponding to the sequence of characters. In some configurations, the default list of lookups can be an “empty” set of lookups such that no lookups are executed at 206 in this scenario. Furthermore a “list” of lookups can comprise a single lookup or multiple lookups.

At 208, the default GSUB/GPOS lookups can be cached in association with the context of the string of text 102. For example, the string of text 102 can be associated with a font type, one or more font design variations (e.g., weight, style, width, x-height, cap-height, style, formality, serif length, friendliness, wonkiness, etc.), a layout direction, and so on. Thus, the rendering engine 112 can cache the default GSUB/GPOS lookups in association with such information at 208 so that subsequent strings of text received by the rendering engine 112 can be processed with the default GSUB/GPOS lookups at 206 without evaluating conditions at 204. This conserves processing resources on subsequent glyph processing operations where strings of text 102 with similar properties and attributes can be processed faster and processing efficiency can be increased as a result.

At 210, the string of text 102 is rendered on a display 106 as a sequence of glyphs with a typographical feature applied to the sequence of glyphs. For example, if a default GSUB lookup is executed at 206 to apply a standard ligature feature to the string of text 102, the string of text 102 is rendered at 208 with the standard ligature feature applied, which involves replacing multiple glyph IDs in the sequence of glyph IDs with a standard ligature glyph ID (e.g., replacing “f” and “i” glyph IDs with the “fi” ligature glyph ID).

If, at 204, the rendering engine 112 determines that the set of conditions is satisfied, the process 200 proceeds down the “Yes” path to 212 where an alternate list of lookups is determined and executed in lieu of the default list of lookups that would have been executed at 206 in the event that the set of conditions was not satisfied. Execution of the alternate list of lookups causes a glyph substitution (i.e., GSUB lookups) or a glyph positioning (i.e., GPOS lookups) operation(s) to be performed on the sequence of glyph IDs corresponding to the sequence of characters. It is to be appreciated that, in a scenario where the default list of lookups that would have been executed at 206 comprises an empty set of lookups, the evaluation of the condition set at 204 can be utilized to selectively “turn on” a GSUB/GPOS action by executing an alternate lookup at 212 when the condition set is satisfied at 204. In another scenario, where the alternate list of lookups is an “empty” set of lookups, the evaluation of the condition set at 204 can be utilized to selectively “turn off” a GSUB/GPOS action by refraining from executing any GSUB/GPOS action when the condition set is satisfied at 204, but otherwise executing a default GSUB/GPOS action at 206 when the condition set is not satisfied at 204. In other configurations where neither the default lookup list nor alternate lookup list are empty sets, a replacement of an alternate GSUB/GPOS action for a default GSUB/GPOS action can be implemented with the process 200 of FIG. 2.

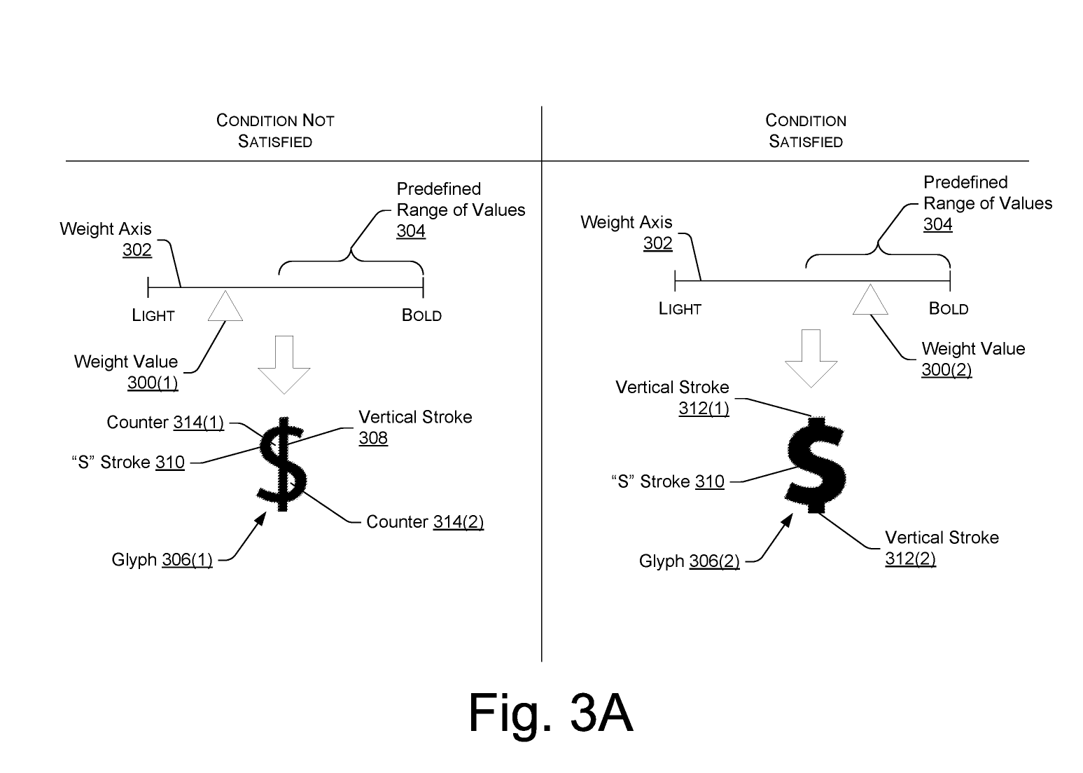

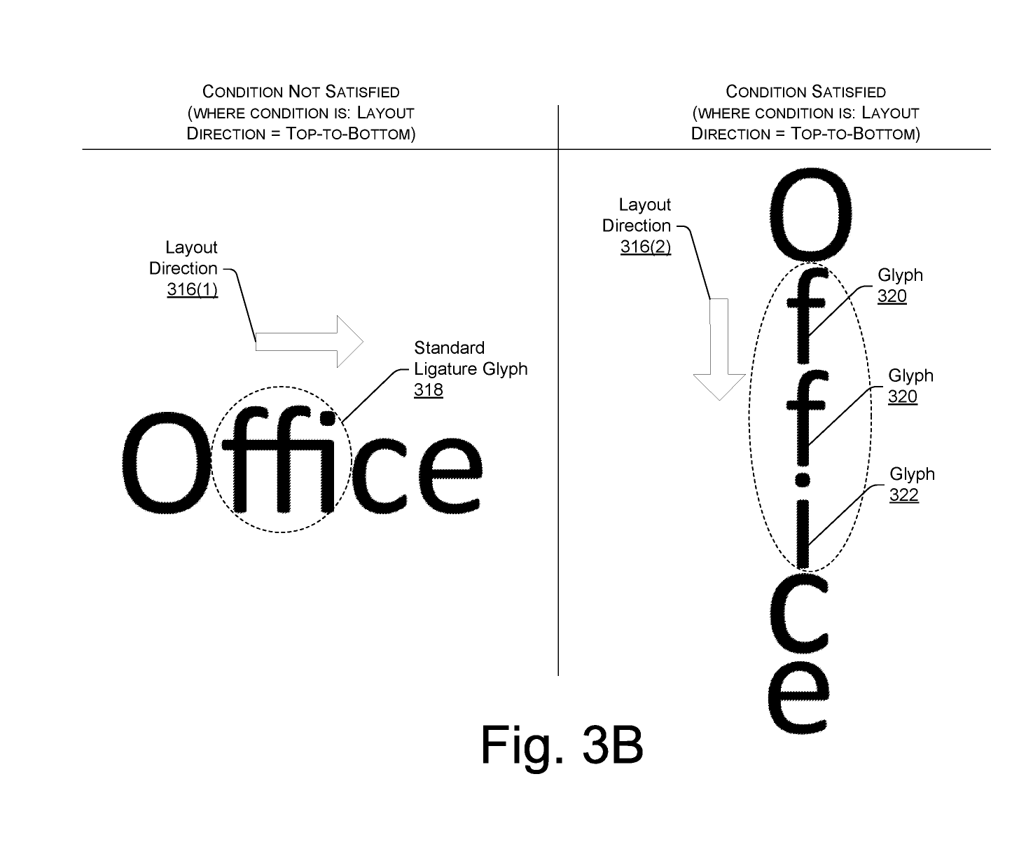

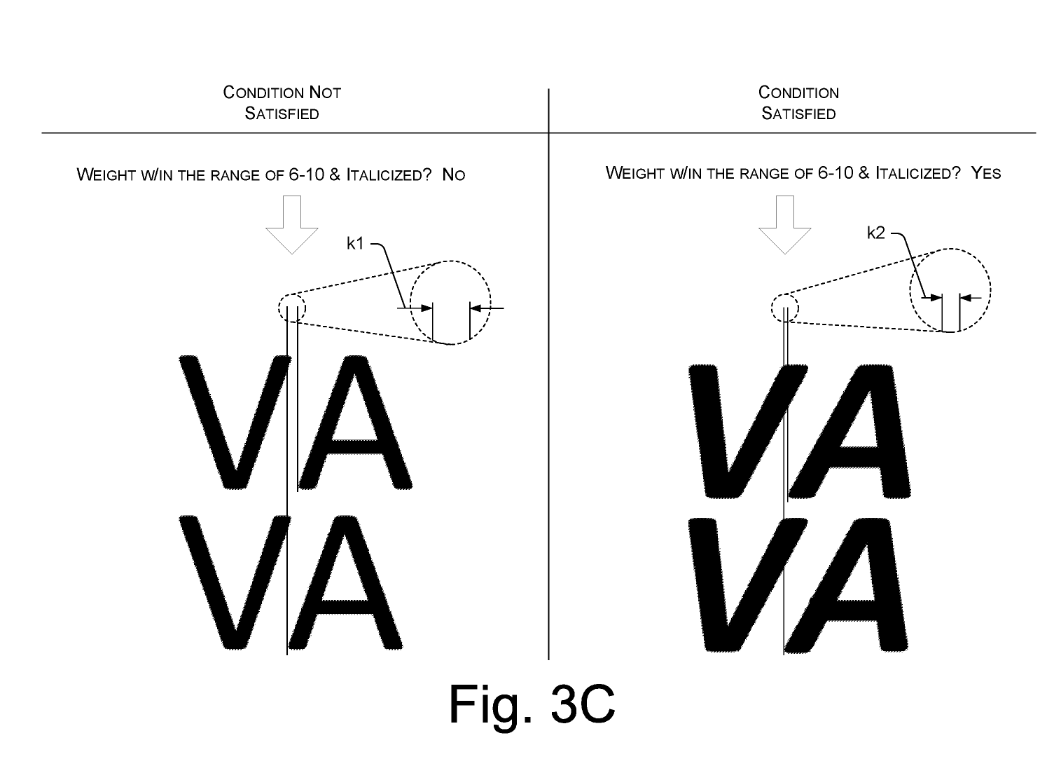

The process 200 proceeds from 212 to 214 to cache the alternate GSUB/GPOS lookups in association with the context of the string of text 102, and ultimately to 210 where the string of text 102 is rendered based on execution of the alternate lookup at 212 in order to apply a typographical feature to the sequence of glyphs that are rendered at 210. Illustrative examples of performing the process 200 will now be described with reference to FIGS. 3A-3C.

FIG. 3A is a schematic diagram of an example conditional filtering scenario. With reference to the process 200, the left side of FIG. 3A illustrates a scenario when the determination at 204 is that the condition is not satisfied, which causes the process 200 to proceed down the “No” path to 206, and ultimately to 210. In the example of FIG. 3A, the context of the string of text 102 under evaluation at 204 comprises a weight value 300(1) on a weight axis 302. Although “weight” is used in the example of FIG. 3A, it is to be appreciated that any instance value for any font design variation axis can be evaluated in a similar manner. The condition under evaluation at 204 can be defined in terms of a predefined range of values 304 such that the context satisfies the condition if the weight value 300(1) is within the predefined range of values 304 on the font design variation axis 302. The left side of FIG. 3A illustrates an example glyph 306(1) that can be rendered at 210 when the condition is not satisfied (e.g., the weight value 300(1) is not within the predefined range of values 304. The glyph 306(1) can be a default glyph specified in the cmap table such that a set of default GSUB lookups defined for the language in question may not include any GSUB lookups that replace the default glyph 306(1). Alternatively, the glyph 306(1) can be a substitute glyph that is rendered as a result of a default GSUB lookup executed at 206 of the process 200. The glyph 306(1) is shown as a “dollar sign” glyph 306(1) having a vertical stroke 308 that extends over the entire “S” stroke 310. This glyph 306(1) is still legible at the weight value 300(1).

The right side of FIG. 3A illustrates a scenario when the determination at 204 is that the condition is satisfied, which causes the process 200 to proceed down the “Yes” path to 212, and ultimately to 210. In the right side of FIG. 3A, the weight value 300(2) is within the predefined range of values 304 on the weight axis 302, which satisfies the condition, and causes a glyph 306(2) to be rendered at 210. The rendering of the glyph 306(2) can be based on executing an alternate GSUB lookup at 212 of the process 200 that replaces the glyph ID corresponding to the glyph 306(1) with the glyph ID corresponding to the glyph 306(2). Notably, the glyph 306(2) is shown as having a small vertical stroke 312(1) at the top of the “S” stroke 310, and a small vertical stroke 312(2) at the bottom of the “S” stroke 310, which preserves the legibility of the glyph 306(2) at the higher weight value 300(2). If the conditional filtering technique of FIG. 3A were not applied, the default glyph 306(1) may have been rendered despite the heavier weight value 300(2), and the counters 314(1) and 314(2) of the glyph 306(1) would have been closed up, and the glyph 306(1) rendered at the weight value 300(2) would look like an illegible black blob. Accordingly, the conditional filtering process 200 preserves the legibility of the string of text 102.

FIG. 3B is a schematic diagram of another example conditional filtering scenario. In the example of FIG. 3B, the context under evaluation at 204 of the process 200 comprises a layout direction 316 of the string of text 102, and the condition under evaluation at 204 is satisfied when the layout direction 316 is top-to-bottom. In the left side of FIG. 3B, the layout direction 316(1) is left-to-right, so the condition is not satisfied, and the default GSUB lookups executed at 206 for a standard ligature feature replaces default glyph IDs for the “f” character followed by the “f” character followed by the “i” character with a glyph ID for the “ffi” standard ligature glyph 318.

In the right side of FIG. 3B, the layout direction 316(2) is top-to-bottom, so the condition is satisfied, and the process 200 proceeds to 212 where an alternate set of GSUB lookups are determined for the standard ligature feature. The alternate set of GSUB lookups may include a list of GSUB lookups that does not include the GSUB lookup for replacing the default glyph IDs for the “f” character followed by the “f” character followed by the “i” character with a glyph ID for the “ffi” standard ligature glyph 318. Instead, the feature table for the standard ligature feature can include no GSUB lookups so that the glyph 320 for the two individual “f” characters and the glyph 322 for the “i” character are rendered in a sequence of glyphs for the word “Office.”

FIG. 3C is a schematic diagram of another example conditional filtering scenario. In the example of FIG. 3C, the context under evaluation at 204 of the process 200 comprises a combination of font attributes for the string of text 102; namely a weight value and a style (e.g., italicized, upright, small caps, etc.). Furthermore, the condition under evaluation at 204 can be defined in terms of a set of conditions that are to all be satisfied (i.e. Boolean: AND). In this case, the condition is satisfied if the weight value is within a predefined range of values (e.g., 6-10) and the style is “italicized”. In the left side of FIG. 3C, the condition is not satisfied because either or both of the weight value of the string of text 102 is not within the predefined range of weight values and/or the style is not italicized. Thus, the process 200 proceeds from 204 to 206 where a default GPOS lookup is performed to apply a kerning feature by decreasing the advance width of the glyph ID for the “V” character by a distance of “k1.” In the right side of FIG. 3C, the condition is satisfied because the weight value of the string of text 102 is within the predefined range of weight values and the style is italicized. Thus, the process 200 proceeds from 204 to 212 where an alternate GPOS lookup is performed to apply the kerning feature by decreasing the advance width of the glyph ID for the “V” character by a different distance of “k2.” Here, the distance, k2, is less than the distance, k1, so that the extent to which the kerning feature is applied depends on the condition being satisfied or not.

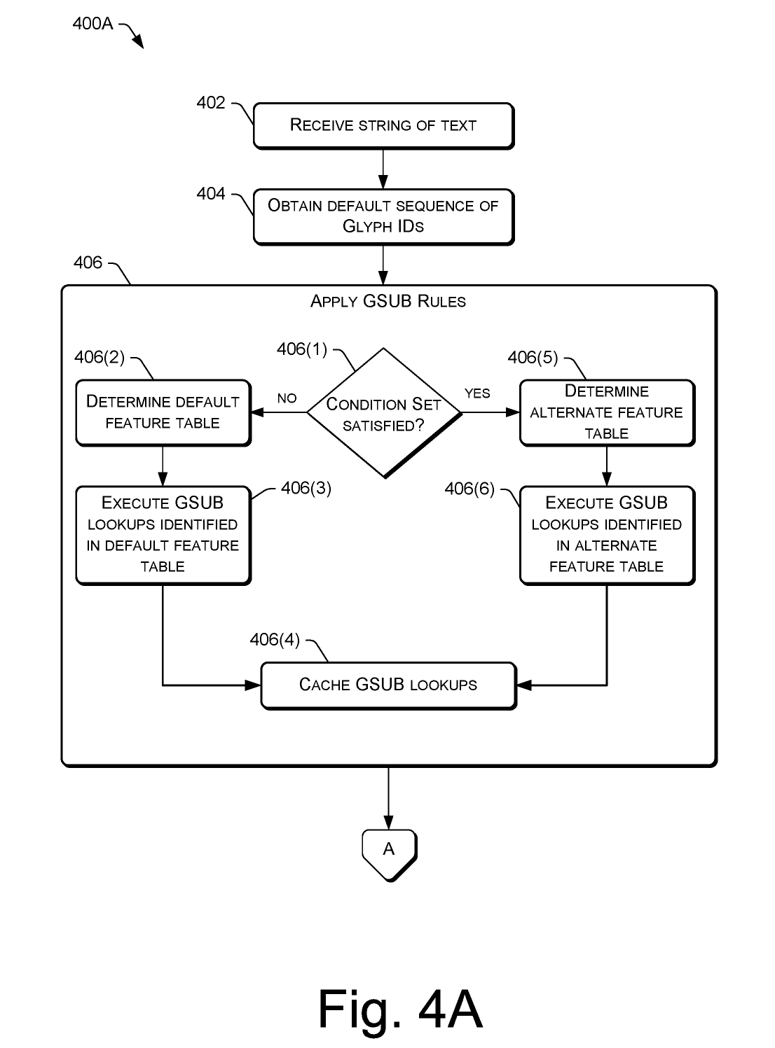

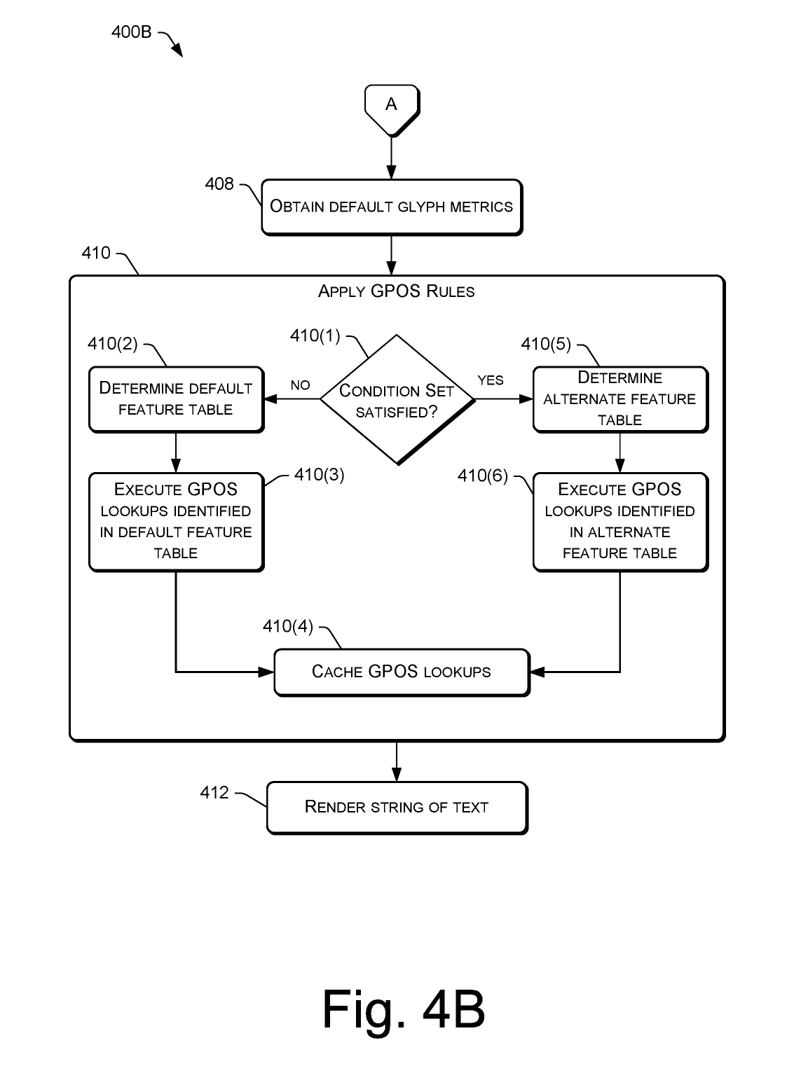

FIG. 4A is a flow diagram of a more detailed example process 400A of conditionally determining GSUB lookups. The process 400A is described with reference to the previous Figures.

At 402, the rendering engine 112 receives a string of text 102. The string of text 102 can comprise a sequence of characters associated with a language. The string of text 102 can also be associated with attributes such as a font (e.g., Arial), one or more font design variation attributes (e.g., weight, style, etc.), a layout direction, and so on.

At 404, the rendering engine 112 obtains a default sequence of glyph IDs. In order to obtain the default sequence of glyph IDs, the rendering engine 112 can reference a cmap table for the font file in question, which contains a default glyph mapping from each character to a default glyph ID.

At 406, the rendering engine 112 applies GSUB rules to apply one or more typographical features (e.g., standard ligatures, historic ligatures, small capitals, etc.). Applying GSUB rules at 406 can involve a sub-process where, at 406(1), a determination is made as to whether a context of the string of text 102 satisfies a set of conditions. The set of conditions can be specified in the feature variations table 122(1) of the GSUB table 116. In an illustrative example, at least one of the conditions at 406(1) can be specified as determining whether a weight value of the string of text 102 is within a predefined range of weight values.

If, at 406(1), the rendering engine 112 determines that the condition set is not satisfied, the process 400A proceeds down the “No” path to 406(2) where a default feature table associated with the language in question is determined. The determination at 406(2) can involve processing a language system table to determine a feature table for a relevant feature for the language in question. Furthermore, the determination at 406(2) can comprise determining a default set of glyph substitution (GSUB) actions via any other suitable data structure besides a feature table.

At 406(3) a list of GSUB lookups identified in the default feature table is executed to cause a glyph substitution operation(s) to be performed on the default sequence of glyph IDs corresponding to the sequence of characters. For example, a standard ligature glyph can be substituted for multiple default glyphs to apply a standard ligature feature via the GSUB lookup executed at 406(3). It is to be appreciated that glyph “substitution” actions can comprise replacing one or more glyphs for another glyph(s), adding or inserting a glyph to an existing sequence of glyphs, removing or deleting a glyph from an existing sequence of glyphs, and/or reordering glyphs in a sequence of glyphs.

At 406(4), the default GSUB lookups can be cached in association with the context of the string of text 102 so that processing cost can be minimized in subsequent text string processing.

If, at 406(1), the rendering engine 112 determines that the set of conditions is satisfied, the process 400A proceeds down the “Yes” path to 406(5) where an alternate feature table is determined for use in lieu of a default feature table, such as the default feature table that would otherwise be determined at 406(2) if the condition set is not satisfied. The alternate feature table can correspond to a typographical feature that is to be applied to the string of text 102. Furthermore, the determination at 406(5) can comprise determining an alternate set of glyph substitution (GSUB) actions, via any other suitable data structure besides a feature table, that are to be used in lieu of a default set of GSUB actions.

At 406(6), a GSUB lookup identified in the alternate feature table is executed to cause a different glyph substitution operation to be performed on the default sequence of glyph IDs corresponding to the sequence of characters. For example, a different glyph ID with a reduced number or extent of strokes can replace a default glyph ID with a relatively higher number of strokes to preserve legibility when the condition is based on a range of weight values. Again, it is to be appreciated that glyph “substitution” actions resulting from the execution of GSUB lookups at 406(6) can comprise replacing one or more glyphs for another glyph(s), adding or inserting a glyph to an existing sequence of glyphs, removing or deleting a glyph from an existing sequence of glyphs, and/or reordering glyphs in a sequence of glyphs.

The process 400A proceeds from 406(6) to 406(4) to cache the GSUB lookups executed at 406(6) in association with the context of the string of text 102 so that processing cost can be minimized in subsequent text string processing.

FIG. 4B is a flow diagram of a more detailed example process 400B of conditionally determining GPOS lookups. The process 400B is described with reference to the previous figures, and can continue from step 406(4) of the process 400A, as shown by the off-page reference “A” in FIGS. 4A and 4B.

At 408, the rendering engine 112 can obtain a set of default glyph metrics associated with the sequence of glyph IDs resulting from application of the GSUB rules at 406. For example, one or more default glyph IDs obtained at 404 can be replaced with one or more substitute glyph IDs as a result of a GSUB lookup executed at 406, and will result in a different sequence of glyph IDs. The default glyph metrics define the respective positions for the glyph IDs in the different sequence of glyph IDs by defining metrics such as advance width, baseline positions, and the like.

At 410, the rendering engine 112 applies GPOS rules to apply one or more typographical features (e.g., kerning). Applying GPOS rules at 410 can involve a sub-process that is similar to the sub-process described with reference to FIG. 4A at 406 in that a set of conditions is evaluated at 410(1). If the set of conditions is not satisfied at 410(1), the process 400B proceeds to 410(2) where a default feature table is determined. The determination at 410(2) can comprise determining a default set of glyph positioning (GPOS) actions via any other suitable data structure besides a feature table.

At 410(3), a list of GPOS lookups identified in the default feature table are executed. In an illustrative example, a GPOS lookup to apply kerning with a reduction in advance width of a distance, k1, for a particular glyph ID in the sequence of glyph IDs can be executed at 410(3) (See FIG. 3C). It is to be appreciated that glyph “positioning” actions resulting from execution of the list of GPOS lookups can comprise adjustment of default glyph metrics, positioning of accent marks around a base glyph, or any suitable glyph positioning action.

At 410(4) the GPOS lookups executed at 410(3) can be cached in association with the context of the string of text 102 so that processing cost can be minimized in subsequent text string processing.

If the conditions are satisfied at 410(1), the process 400B proceeds to 410(5) where an alternate feature table is determined. The determination at 410(5) can comprise determining an alternate set of glyph positioning (GPOS) actions, via any other suitable data structure besides a feature table, that are to be used in lieu of a default set of GPOS actions. The process 400B proceeds from 410(5) to 410(6) where a list of GPOS lookups identified in the alternate feature table are executed. In an illustrative example, a GPOS lookup to apply kerning with a reduction in advance width of a distance, k2, for a particular glyph ID in the sequence of glyph IDs can be executed at 410(6), the distance, k2, being different than the distance, k1. (See FIG. 3C). Again, it is to be appreciated that glyph “positioning” actions resulting from execution of the list of GPOS lookups at 410(6) can comprise adjustment of default glyph metrics, positioning of accent marks around a base glyph, or any suitable glyph positioning action.

At 410(4) the GPOS lookups executed at 410(6) can be cached in association with the context of the string of text 102 so that processing cost can be minimized in subsequent text string processing.

At 412, the string of text 102 is rendered on a display 106 as a sequence of glyphs corresponding to the sequence of glyph IDs resulting from the GSUB lookups executed at 406 of FIG. 4A. The sequence of glyphs rendered at 412 will also be rendered in positions resulting from the GPOS lookups executed at 410 of FIG. 4B. In this manner, conditional filtering can be applied to render a string of text as a sequence of glyphs at 412 using the processes 400A and 400B. It is to be appreciated that the rendering step at 412 can be performed by a client device, such as the computing device 100 of FIG. 1. In thin-client implementations where the steps of the processes disclosed herein are performed by a server computer that is different from the computing device 100, the server computer can cause the string of text 102 to be rendered on a display of the computing device 100 at 412. Alternatively, if the computing device 100 does not have a display, but is usable with a peripheral display, the computing device 100 can cause the string of text 102 to be rendered on a peripheral display at 412.

The environment and individual elements described herein can of course include many other logical, programmatic, and physical components, of which those shown in the accompanying figures are merely examples that are related to the discussion herein.

The various techniques described herein are assumed in the given examples to be implemented in the general context of computer-executable instructions or software, such as program modules, that are stored in computer-readable storage and executed by the processor(s) of one or more computers or other devices such as those illustrated in the figures. Generally, program modules include routines, programs, objects, components, data structures, etc., and define operating logic for performing particular tasks or implement particular abstract data types.

Other architectures can be used to implement the described functionality, and are intended to be within the scope of this disclosure. Furthermore, although specific distributions of responsibilities are defined above for purposes of discussion, the various functions and responsibilities might be distributed and divided in different ways, depending on circumstances.

Similarly, software can be stored and distributed in various ways and using different means, and the particular software storage and execution configurations described above can be varied in many different ways. Thus, software implementing the techniques described above can be distributed on various types of computer-readable media, not limited to the forms of memory that are specifically described.

### Example One

A method comprising: receiving a string of text comprising a sequence of characters associated with a language; obtaining a default sequence of glyph identifiers (IDs) corresponding to the sequence of characters; applying glyph substitution rules associated with the language by: determining that a context of the string of text satisfies a set of conditions; in response to determining that the context satisfies the set of conditions, determining an alternate set of glyph substitution actions to use in lieu of a default set of glyph substitution actions, the alternate set of glyph substitution actions corresponding to a typographical feature that is to be applied to the string of text; and executing a glyph substitution action of the alternate set of glyph substitution actions, wherein executing the glyph substitution action results in a different sequence of glyph IDs; and causing the string of text to be rendered on a display as a sequence of glyphs corresponding to the different sequence of glyph IDs.

### Example Two

The method of Example One, wherein the context comprises a value on a font design variation axis, and wherein determining that the context satisfies the set of conditions comprises determining that the value is within a predefined range of values on the font design variation axis.

### Example Three

The method of any of the previous examples, alone or in combination, wherein the font design variation axis comprises a weight axis that defines a continuum of weight values, and wherein the value comprises a weight value associated with the string of text.

### Example Four

The method of any of the previous examples, alone or in combination, wherein data that represents the set of conditions and the alternate set of glyph substitution actions is included within an additional data structure within an existing font data structure such that a legacy system that does not utilize or recognize the data outputs a sequence of positioned glyphs in response to processing the existing font data structure containing the additional data structure.

### Example Five

The method of any of the previous examples, alone or in combination, further comprising, prior to causing the string of text to be rendered on the display: obtaining default glyph metrics associated with the different sequence of glyph IDs; and processing glyph positioning rules associated with the language by: determining that the context, or a different context, of the string of text, satisfies a second set of conditions; in response to determining that the context, or the different context, satisfies the second set of conditions, determining an alternate set of glyph positioning actions to use in lieu of a default set of glyph positioning actions, the alternate set of glyph positioning actions corresponding to a second typographical feature that is to be applied to the string of text; and executing a glyph positioning action of the set of glyph positioning actions to transform the default glyph metrics into adjusted glyph metrics; and wherein causing the string of text to be rendered on the display comprises positioning the sequence of glyphs based at least in part on the adjusted glyph metrics.

### Example Six

The method of any of the previous examples, alone or in combination, wherein the context comprises a layout direction, and wherein determining that the context satisfies the set of conditions comprises determining that the layout direction is at least one of left-to-right, right-to-left, top-to-bottom, or bottom-to-top.

### Example Seven

The method of any of the previous examples, alone or in combination, wherein the context comprises a version of a font format, and wherein determining that the context satisfies the set of conditions comprises determining that the version of the font format is at or above a minimum version of the font format.

### Example Eight

A system comprising: one or more processors (e.g., central processing units (CPUs), field programmable gate array (FPGAs), complex programmable logic devices (CPLDs), application specific integrated circuits (ASICs), system-on-chips (SoCs), etc.); and memory (e.g., RAM, ROM, EEPROM, flash memory, etc.) storing: at least one data structure specifying a set of conditions for executing lookups for purposes of glyph substitution in lieu of default lookups; and computer-executable instructions that, when executed by the one or more processors, cause the one or more processors to perform operations comprising: receiving a string of text comprising a sequence of characters associated with a language; obtaining a default sequence of glyph identifiers (IDs) corresponding to the sequence of characters; applying glyph substitution rules associated with the language by: determining, by processing the at least one data structure, that a context of the string of text satisfies a set of conditions; in response to determining that the context satisfies the set of conditions, determining an alternate set of glyph substitution actions to use in lieu of a default set of glyph substitution actions, the alternate set of glyph substitution actions corresponding to a typographical feature that is to be applied to the string of text; and executing a glyph substitution action of the alternate set of glyph substitution actions, wherein executing the glyph substitution action results in a different sequence of glyph IDs; and causing the string of text to be rendered on a display as a sequence of glyphs corresponding to the different sequence of glyph IDs.

### Example Nine

The system of Example Eight, wherein the context comprises a value on a font design variation axis, and wherein determining that the context satisfies the set of conditions comprises determining that the value is within a predefined range of values on the font design variation axis.

### Example Ten

The system of any of the previous examples, alone or in combination, wherein the font design variation axis comprises a weight axis that defines a continuum of weight values, and wherein the value comprises a weight value associated with the string of text.

### Example Eleven

The system of any of the previous examples, alone or in combination, wherein data that represents the set of conditions and the alternate set of glyph substitution actions is included within the at least one data structure within an existing font data structure such that a legacy system that does not utilize or recognize the data outputs a sequence of positioned glyphs in response to processing the existing font data structure containing the at least one data structure.

### Example Twelve

The system of any of the previous examples, alone or in combination, wherein the at least one data structure further specifies a second set of conditions for executing alternate lookups for purposes of glyph positioning in lieu of default lookups, the operations further comprising, prior to causing the string of text to be rendered on the display: obtaining default glyph metrics associated with the different sequence of glyph IDs; and processing glyph positioning rules associated with the language by: determining, by processing the at least one data structure, that the context, or a different context, of the string of text, satisfies the second set of conditions; in response to determining that the context, or the different context, satisfies the second set of conditions, determining an alternate set of glyph positioning actions to use in lieu of a default set of glyph positioning actions, the alternate set of glyph positioning actions corresponding to a second typographical feature that is to be applied to the string of text; and executing a glyph positioning action of the set of glyph positioning actions to transform the default glyph metrics into adjusted glyph metrics; and wherein causing the string of text to be rendered on the display comprises positioning the sequence of glyphs based at least in part on the adjusted glyph metrics.

### Example Thirteen

The system of any of the previous examples, alone or in combination, wherein the context comprises a layout direction, and wherein determining that the context satisfies the set of conditions comprises determining that the layout direction is at least one of left-to-right, right-to-left, top-to-bottom, or bottom-to-top.

### Example Fourteen

The system of any of the previous examples, alone or in combination, wherein the context comprises a version of a font format, and wherein determining that the context satisfies the set of conditions comprises determining that the version of the font format is at or above a minimum version of the font format.

### Example Fifteen

One or more computer-readable storage media (e.g., RAM, ROM, EEPROM, flash memory, etc.) storing: at least one data structure specifying a set of conditions for executing lookups for purposes of glyph substitution in lieu of default lookups; and computer-executable instructions that, when executed by a processor (e.g., central processing unit (CPU), a field programmable gate array (FPGA), a complex programmable logic device (CPLD), an application specific integrated circuit (ASIC), a system-on-chip (SoC), etc.), perform operations comprising: receiving a string of text comprising a sequence of characters associated with a language; obtaining a default sequence of glyph identifiers (IDs) corresponding to the sequence of characters; applying glyph substitution rules associated with the language by: determining, by processing the at least one data structure, that a context of the string of text satisfies a set of conditions; in response to determining that the context satisfies the set of conditions, determining an alternate set of glyph substitution actions to use in lieu of a default set of glyph substitution actions, the alternate set of glyph substitution actions corresponding to a typographical feature that is to be applied to the string of text; and executing a glyph substitution action of the alternate set of glyph substitution actions, wherein executing the glyph substitution action results in a different sequence of glyph IDs; and causing the string of text to be rendered on a display as a sequence of glyphs corresponding to the different sequence of glyph IDs.

### Example Sixteen

The one or more computer-readable storage media of Example Fifteen, wherein the context comprises a value on a font design variation axis, and wherein determining that the context satisfies the set of conditions comprises determining that the value is within a predefined range of values on the font design variation axis.

### Example Seventeen

The one or more computer-readable storage media of any of the previous examples, alone or in combination, wherein the font design variation axis comprises a weight axis that defines a continuum of weight values, and wherein the value comprises a weight value associated with the string of text.

### Example Eighteen

The one or more computer-readable storage media of any of the previous examples, alone or in combination, wherein data that represents the set of conditions and the alternate set of glyph substitution actions is included within the at least one data structure within an existing font data structure such that a legacy system that does not utilize or recognize the data outputs a sequence of positioned glyphs in response to processing the existing font data structure containing the at least one data structure.

### Example Nineteen

The one or more computer-readable storage media of any of the previous examples, alone or in combination, wherein the at least one data structure further specifies a second set of conditions for executing alternate lookups for purposes of glyph positioning in lieu of default lookups, the operations further comprising, prior to causing the string of text to be rendered on the display: obtaining default glyph metrics associated with the different sequence of glyph IDs; and processing glyph positioning rules associated with the language by: determining, by processing the at least one data structure, that the context, or a different context, of the string of text, satisfies the second set of conditions; in response to determining that the context, or the different context, satisfies the second set of conditions, determining an alternate set of glyph positioning actions to use in lieu of a default set of glyph positioning actions, the alternate set of glyph positioning actions corresponding to a second typographical feature that is to be applied to the string of text; and executing a glyph positioning action of the set of glyph positioning actions to transform the default glyph metrics into adjusted glyph metrics; and wherein causing the string of text to be rendered on the display comprises positioning the sequence of glyphs based at least in part on the adjusted glyph metrics.

### Example Twenty

The one or more computer-readable storage media of any of the previous examples, alone or in combination, wherein the context comprises a layout direction, and wherein determining that the context satisfies the set of conditions comprises determining that the layout direction is at least one of left-to-right, right-to-left, top-to-bottom, or bottom-to-top.

### Example Twenty-One

The one or more computer-readable storage media of any of the previous examples, alone or in combination, wherein the context comprises a version of a font format, and wherein determining that the context satisfies the set of conditions comprises determining that the version of the font format is at or above a minimum version of the font format.

### Example Twenty-Two

A method comprising: receiving a string of text comprising a sequence of characters; obtaining a sequence of glyph identifiers (IDs) corresponding to the sequence of characters; determining that a context of the string of text satisfies a condition; in response to determining that the context satisfies the condition, determining an alternate lookup to execute in lieu of a default lookup, the alternate lookup being usable to implement a typographical feature; executing the alternate lookup, wherein executing the alternate lookup causes a glyph substitution operation or a glyph positioning operation to be performed on the sequence of glyph IDs; and causing the string of text to be rendered on a display as a sequence of glyphs with the typographical feature applied to the sequence of glyphs.

### Example Twenty-Three

The method of Example Twenty-Two, wherein determining the alternate lookup to execute comprises determining an alternate feature table to use in lieu of a default feature table, the alternate feature table corresponding to the typographical feature and including a list of lookup references, the list of lookup references in the alternate feature table including a lookup reference corresponding to the alternate lookup.

### Example Twenty-Four

The method of any of the previous examples, alone or in combination, wherein determining the alternate feature table comprises, in response to the condition being satisfied, processing a data structure for the condition to determine a plurality of feature table substitution tables, at least one feature table substitution table of the plurality of feature table substitution tables comprising a correlation between the alternate feature table and the default feature table.

### Example Twenty-Five

The method of any of the previous examples, alone or in combination, wherein the context comprises a value on a font design variation axis, and wherein determining that the context satisfies the condition comprises determining that the value is within a predefined range of values on the font design variation axis.

### Example Twenty-Six

The method of any of the previous examples, alone or in combination, wherein the font design variation axis comprises a weight axis that defines a continuum of weight values, and wherein the value comprises a weight value associated with the string of text.

### Example Twenty-Seven

The method of any of the previous examples, alone or in combination, wherein the context comprises a layout direction, and wherein determining that the context satisfies the condition comprises determining that the layout direction is at least one of left-to-right, right-to-left, top-to-bottom, or bottom-to-top.

### Example Twenty-Eight

The method of any of the previous examples, alone or in combination, further comprising caching the alternate lookup in association with the context of the string of text.

### Example Twenty-Nine

The method of any of the previous examples, alone or in combination, wherein: the sequence of glyph IDs comprises a default sequence of glyph IDs corresponding to the sequence of characters; the glyph substitution operation is performed by replacing at least one default glyph ID in the default sequence of glyph IDs with at least one substitute glyph ID resulting in a different sequence of glyph IDs; and the sequence of glyphs corresponds to the different sequence of glyph IDs.

### Example Thirty

The method of any of the previous examples, alone or in combination, further comprising, prior to causing the string of text to be rendered on the display, obtaining default glyph metrics associated with the sequence of glyph IDs, wherein: the glyph positioning operation is performed by transforming the default glyph metrics into adjusted glyph metrics; and the sequence of glyphs are rendered on the display at positions according to the adjusted glyph metrics.

### Example Thirty-One

A system comprising: one or more processors (e.g., central processing units (CPUs), field programmable gate array (FPGAs), complex programmable logic devices (CPLDs), application specific integrated circuits (ASICs), system-on-chips (SoCs), etc.); and memory (e.g., RAM, ROM, EEPROM, flash memory, etc.) storing at least one data structure specifying a set of conditions for executing alternate lookups for purposes of glyph substitution or glyph positioning in lieu of default lookups; and computer-executable instructions that, when executed by the one or more processors, cause the one or more processors to perform operations comprising: receiving a string of text comprising a sequence of characters; obtaining a sequence of glyph identifiers (IDs) corresponding to the sequence of characters; determining, by processing the at least one data structure, that a context of the string of text satisfies a condition in the set of conditions; in response to determining that the context satisfies the condition, determining an alternate lookup to execute in lieu of a default lookup, the alternate lookup being usable to implement a typographical feature; executing the alternate lookup, wherein executing the alternate lookup causes a glyph substitution operation or a glyph positioning operation to be performed on the sequence of glyph IDs; and causing the string of text to be rendered on a display as a sequence of glyphs with the typographical feature applied to the sequence of glyphs.

### Example Thirty-Two

The system of Example Thirty-One, wherein the context comprises a value on a font design variation axis, and wherein determining that the context satisfies the condition comprises determining that the value is within a predefined range of values on the font design variation axis.

### Example Thirty-Three

The system of any of the previous examples, alone or in combination, wherein determining the alternate lookup to execute comprises determining an alternate feature table to use in lieu of a default feature table, the alternate feature table corresponding to the typographical feature and including a list of lookup references, the list of lookup references in the alternate feature table including a lookup reference corresponding to the alternate lookup.

### Example Thirty-Four

The system of any of the previous examples, alone or in combination, wherein: the sequence of glyph IDs comprises a default sequence of glyph IDs corresponding to the sequence of characters; the glyph substitution operation is performed by replacing at least one default glyph ID in the default sequence of glyph IDs with at least one substitute glyph ID resulting in a different sequence of glyph IDs; and the sequence of glyphs corresponds to the different sequence of glyph IDs.

### Example Thirty-Five

One or more computer-readable storage media (e.g., RAM, ROM, EEPROM, flash memory, etc.) storing: at least one data structure specifying a set of conditions for executing alternate lookups for purposes of glyph substitution or glyph positioning in lieu of default lookups; and computer-executable instructions that, when executed by a processor (e.g., central processing unit (CPU), a field programmable gate array (FPGA), a complex programmable logic device (CPLD), an application specific integrated circuit (ASIC), a system-on-chip (SoC), etc.), perform operations comprising: receiving a string of text comprising a sequence of characters; obtaining a sequence of glyph identifiers (IDs) corresponding to the sequence of characters; determining, by processing the at least one data structure, that a context of the string of text satisfies a condition in the set of conditions; in response to determining that the context satisfies the condition, determining an alternate lookup to execute in lieu of a default lookup, the alternate lookup being usable to implement a typographical feature; executing the alternate lookup, wherein executing the alternate lookup causes a glyph substitution operation or a glyph positioning operation to be performed on the sequence of glyph IDs; and causing the string of text to be rendered on a display as a sequence of glyphs with the typographical feature applied to the sequence of glyphs.

### Example Thirty-Six

The one or more computer-readable storage media of Example Thirty-Five, wherein the context comprises a value on a font design variation axis, and wherein determining that the context satisfies the condition comprises determining that the value is within a predefined range of values on the font design variation axis.

### Example Thirty-Seven

The one or more computer-readable storage media of any of the previous examples, alone or in combination, wherein determining the alternate lookup to execute comprises determining an alternate feature table to use in lieu of a default feature table, the alternate feature table corresponding to the typographical feature and including a list of lookup references, the list of lookup references in the alternate feature table including a lookup reference corresponding to the alternate lookup.

### Example Thirty-Eight

The one or more computer-readable storage media of any of the previous examples, alone or in combination, wherein: the sequence of glyph IDs comprises a default sequence of glyph IDs corresponding to the sequence of characters; the glyph substitution operation is performed by replacing at least one default glyph ID in the default sequence of glyph IDs with at least one substitute glyph ID resulting in a different sequence of glyph IDs; and the sequence of glyphs corresponds to the different sequence of glyph IDs.

### Example Thirty-Nine

A system comprising: means for executing computer-executable instructions (e.g., central processing unit (CPU), a field programmable gate array (FPGA), a complex programmable logic device (CPLD), an application specific integrated circuit (ASIC), a system-on-chip (SoC), etc.); and means for storing (e.g., RAM, ROM, EEPROM, flash memory, etc.): at least one data structure specifying a set of conditions for executing lookups for purposes of glyph substitution in lieu of default lookups; and computer-executable instructions that, when executed by the means for executing computer-executable instructions, perform operations comprising: receiving a string of text comprising a sequence of characters associated with a language; obtaining a default sequence of glyph identifiers (IDs) corresponding to the sequence of characters; applying glyph substitution rules associated with the language by: determining, by processing the at least one data structure, that a context of the string of text satisfies a set of conditions; in response to determining that the context satisfies the set of conditions, determining an alternate set of glyph substitution actions to use in lieu of a default set of glyph substitution actions, the alternate set of glyph substitution actions corresponding to a typographical feature that is to be applied to the string of text; and executing a glyph substitution action of the alternate set of glyph substitution actions, wherein executing the glyph substitution action results in a different sequence of glyph IDs; and causing the string of text to be rendered on a display as a sequence of glyphs corresponding to the different sequence of glyph IDs.

### Example Forty

The system of Example Thirty-Nine, wherein the at least one data structure further specifies a second set of conditions for executing alternate lookups for purposes of glyph positioning in lieu of default lookups, the operations further comprising, prior to causing the string of text to be rendered on the display: obtaining default glyph metrics associated with the different sequence of glyph IDs; and processing glyph positioning rules associated with the language by: determining, by processing the at least one data structure, that the context, or a different context, of the string of text, satisfies the second set of conditions; in response to determining that the context, or the different context, satisfies the second set of conditions, determining an alternate set of glyph positioning actions to use in lieu of a default set of glyph positioning actions, the alternate set of glyph positioning actions corresponding to a second typographical feature that is to be applied to the string of text; and executing a glyph positioning action of the set of glyph positioning actions to transform the default glyph metrics into adjusted glyph metrics; and wherein causing the string of text to be rendered on the display comprises positioning the sequence of glyphs based at least in part on the adjusted glyph metrics.

### Example Forty-One

A system comprising: means for executing computer-executable instructions (e.g., central processing unit (CPU), a field programmable gate array (FPGA), a complex programmable logic device (CPLD), an application specific integrated circuit (ASIC), a system-on-chip (SoC), etc.); and means for storing (e.g., RAM, ROM, EEPROM, flash memory, etc.): at least one data structure specifying a set of conditions for executing alternate lookups for purposes of glyph substitution or glyph positioning in lieu of default lookups; and computer-executable instructions that, when executed by the means for executing computer-executable instructions, perform operations comprising: receiving a string of text comprising a sequence of characters; obtaining a sequence of glyph identifiers (IDs) corresponding to the sequence of characters; determining, by processing the at least one data structure, that a context of the string of text satisfies a condition in the set of conditions; in response to determining that the context satisfies the condition, determining an alternate lookup to execute in lieu of a default lookup, the alternate lookup being usable to implement a typographical feature; executing the alternate lookup, wherein executing the alternate lookup causes a glyph substitution operation or a glyph positioning operation to be performed on the sequence of glyph IDs; and causing the string of text to be rendered on a display as a sequence of glyphs with the typographical feature applied to the sequence of glyphs.

### CONCLUSION

In closing, although the various configurations have been described in language specific to structural features and/or methodological acts, it is to be understood that the subject matter defined in the appended representations is not necessarily limited to the specific features or acts described. Rather, the specific features and acts are disclosed as example forms of implementing the claimed subject matter.

What is claimed is:

1. A method comprising:
receiving a string of text comprising a sequence of characters associated with a language;
obtaining a default sequence of glyph identifiers (IDs) corresponding to the sequence of characters;
applying glyph substitution rules associated with the language by:
determining that a context of the string of text satisfies a set of conditions;
in response to determining that the context satisfies the set of conditions, determining an alternate set of glyph substitution actions to use in lieu of a default set of glyph substitution actions, the alternate set of glyph substitution actions corresponding to a typographical feature that is to be applied to the string of text; and
executing a glyph substitution action of the alternate set of glyph substitution actions, wherein executing the glyph substitution action results in a different sequence of glyph IDs; and
causing the string of text to be rendered on a display as a sequence of glyphs corresponding to the different sequence of glyph IDs.

2. The method of claim 1, wherein the context comprises a value on a font design variation axis, and wherein determining that the context satisfies the set of conditions comprises determining that the value is within a predefined range of values on the font design variation axis.

3. The method of claim 2, wherein the font design variation axis comprises a weight axis that defines a continuum of weight values, and wherein the value comprises a weight value associated with the string of text.

4. The method of claim 1, wherein data that represents the set of conditions and the alternate set of glyph substitution actions is included within an additional data structure within an existing font data structure such that a legacy system that does not utilize or recognize the data outputs a sequence of positioned glyphs in response to processing the existing font data structure containing the additional data structure.

5. The method of claim 1, further comprising, prior to causing the string of text to be rendered on the display:
obtaining default glyph metrics associated with the different sequence of glyph IDs; and
processing glyph positioning rules associated with the language by:
determining that the context, or a different context, of the string of text, satisfies a second set of conditions;
in response to determining that the context, or the different context, satisfies the second set of conditions, determining an alternate set of glyph positioning actions to use in lieu of a default set of glyph positioning actions, the alternate set of glyph positioning actions corresponding to a second typographical feature that is to be applied to the string of text; and
executing a glyph positioning action of the set of glyph positioning actions to transform the default glyph metrics into adjusted glyph metrics; and
wherein causing the string of text to be rendered on the display comprises positioning the sequence of glyphs based at least in part on the adjusted glyph metrics.

6. The method of claim 1, wherein the context comprises a layout direction, and wherein determining that the context satisfies the set of conditions comprises determining that the layout direction is at least one of left-to-right, right-to-left, top-to-bottom, or bottom-to-top.

7. The method of claim 1, wherein the context comprises a version of a font format, and wherein determining that the context satisfies the set of conditions comprises determining that the version of the font format is at or above a minimum version of the font format.

8. A method comprising:
receiving a string of text comprising a sequence of characters;
obtaining a sequence of glyph identifiers (IDs) corresponding to the sequence of characters;
determining that a context of the string of text satisfies a condition;
in response to determining that the context satisfies the condition, determining an alternate lookup to execute in lieu of a default lookup, the alternate lookup being usable to implement a typographical feature;
executing the alternate lookup, wherein executing the alternate lookup causes a glyph substitution operation or a glyph positioning operation to be performed on the sequence of glyph IDs; and
causing the string of text to be rendered on a display as a sequence of glyphs with the typographical feature applied to the sequence of glyphs.

9. The method of claim 8, wherein determining the alternate lookup to execute comprises determining an alternate feature table to use in lieu of a default feature table, the alternate feature table corresponding to the typographical feature and including a list of lookup references, the list of lookup references in the alternate feature table including a lookup reference corresponding to the alternate lookup.

10. The method of claim 9, wherein determining the alternate feature table comprises, in response to the condition being satisfied, processing a data structure for the condition to determine a plurality of feature table substitution tables, at least one feature table substitution table of the plurality of feature table substitution tables comprising a correlation between the alternate feature table and the default feature table.

11. The method of claim 8, wherein the context comprises a value on a font design variation axis, and wherein determining that the context satisfies the condition comprises determining that the value is within a predefined range of values on the font design variation axis.

12. The method of claim 11, wherein the font design variation axis comprises a weight axis that defines a continuum of weight values, and wherein the value comprises a weight value associated with the string of text.

13. The method of claim 8, wherein the context comprises a layout direction, and wherein determining that the context satisfies the condition comprises determining that the layout direction is at least one of left-to-right, right-to-left, top-to-bottom, or bottom-to-top.

14. The method of claim 8, further comprising caching the alternate lookup in association with the context of the string of text.

15. The method of claim 8, wherein:
the sequence of glyph IDs comprises a default sequence of glyph IDs corresponding to the sequence of characters;
the glyph substitution operation is performed by replacing at least one default glyph ID in the default sequence of glyph IDs with at least one substitute glyph ID resulting in a different sequence of glyph IDs; and
the sequence of glyphs corresponds to the different sequence of glyph IDs.

16. The method of claim 8, further comprising, prior to causing the string of text to be rendered on the display, obtaining default glyph metrics associated with the sequence of glyph IDs, wherein:
the glyph positioning operation is performed by transforming the default glyph metrics into adjusted glyph metrics; and
the sequence of glyphs are rendered on the display at positions according to the adjusted glyph metrics.

17. A system comprising:
one or more processors; and
memory storing:
at least one data structure specifying a set of conditions for executing alternate lookups for purposes of glyph substitution or glyph positioning in lieu of default lookups; and
computer-executable instructions that, when executed by the one or more processors, cause the one or more processors to perform operations comprising:
receiving a string of text comprising a sequence of characters;
obtaining a sequence of glyph identifiers (IDs) corresponding to the sequence of characters;
determining, by processing the at least one data structure, that a context of the string of text satisfies a condition in the set of conditions;
in response to determining that the context satisfies the condition, determining an alternate lookup to execute in lieu of a default lookup, the alternate lookup being usable to implement a typographical feature;
executing the alternate lookup, wherein executing the alternate lookup causes a glyph substitution operation or a glyph positioning operation to be performed on the sequence of glyph IDs; and
causing the string of text to be rendered on a display as a sequence of glyphs with the typographical feature applied to the sequence of glyphs.

18. The system of claim 17, wherein the context comprises a value on a font design variation axis, and wherein determining that the context satisfies the condition comprises determining that the value is within a predefined range of values on the font design variation axis.

19. The system of claim 17, wherein determining the alternate lookup to execute comprises determining an alternate feature table to use in lieu of a default feature table, the alternate feature table corresponding to the typographical feature and including a list of lookup references, the list of lookup references in the alternate feature table including a lookup reference corresponding to the alternate lookup.

20. The system of claim 17, wherein:
the sequence of glyph IDs comprises a default sequence of glyph IDs corresponding to the sequence of characters;
the glyph substitution operation is performed by replacing at least one default glyph ID in the default sequence of glyph IDs with at least one substitute glyph ID resulting in a different sequence of glyph IDs; and
the sequence of glyphs corresponds to the different sequence of glyph IDs.
